(19) United States
(12) Patent Application Publication
(10) Pub. No.: US 2017/0276902 A1
(43) Pub. Date: Sep. 28, 2017

(54) FOCUS CONTROL DEVICE, IMAGING DEVICE, AND FOCUS CONTROL METHOD

(71) Applicant: HITACHI INDUSTRY & CONTROL SOLUTIONS, LTD., Ibaraki (JP)

(72) Inventors: Iori UMEZAWA, Ibaraki (JP); Hideharu ONO, Ibaraki (JP); Tomoaki NISHIGUCHI, Ibaraki (JP); Toshiyuki YOKOYAMA, Ibaraki (JP); Yukitoshi SHIROTA, Ibaraki (JP)

(73) Assignee: HITACHI INDUSTRY & CONTROL SOLUTIONS, LTD., Ibaraki (JP)

(21) Appl. No.: 15/441,621

(22) Filed: Feb. 24, 2017

(30) Foreign Application Priority Data
Mar. 23, 2016 (JP) 2016-057814

(51) Int. Cl. G02B 7/28; G02B 7/09

(52) U.S. Cl. CPC G02B 7/282; G02B 7/09

(57) ABSTRACT

In order to perform an autofocus operation, a controller of a focus control device selects subject information relating to the current magnification from subject information including previous focus states stored in a storage unit in advance, and determines a focus lens driving range on the basis of a focal length associated with the selected subject information. After the focus lens driving range is determined, a contrast-based autofocus operation is performed within that driving range. Therefore, it is possible to reduce the time taken to obtain the focus state and improve reliability of the focusing.

### BACKGROUND OF THE INVENTION

1. Field of the Invention

The present invention relates to a focus control device, an imaging device, and a focus control method for performing a focus control for a subject.

2. Description of the Related Art

In the prior art, many imaging devices installed in a video recorder such as a monitoring camera or a digital versatile disc (DVD) camera are provided with an autofocus (AF) function capable of automatically controlling focusing. As one of focusing methods for the AF function, there is known a contrast-based method in which focusing is controlled by setting a position of the maximum contrast signal amplitude of a photographic image as a focus state.

In the imaging device, the photographic image has a focus state or a defocus state by shifting the focus lens along its optical axis, and the contrast signal amplitude is also changed accordingly. In a typical contrast-based method, a focusing direction is detected on the basis of a level of the contrast signal amplitude while the focus lens is shifted along its optical axis. Then, the focusing is performed by shifting the focus lens in the detected direction. In the following description, a control for focusing the focus lens using the AF function will be referred to as an “AF control.” In addition, a state of the imaging device for shifting the focus lens on the basis of the AF control or performing a process for executing the AF function will be referred to as an “AF operation.” Furthermore, a state of the imaging device in which the shifting of the focus lens stops during the AF function will be referred to as an “AF standby state.”

The contrast level important in the contrast-based method depends on a subject. Here, how to photograph a subject using the contrast-based method will be described with reference to FIGS. 5A to 5C.

FIG. 5A illustrates a typical subject. A relationship between the focus lens position and the contrast is set as shown in FIG. 5B, in which the contrast-based AF function can be applied.

Next, an exemplary subject photographed at nighttime is illustrated in FIGS. 6A to 6C.

FIGS. 6B and 6C illustrate a relationship between the focus lens position and the contrast signal detected when a low-contrast subject of FIG. 6A is photographed.

The imaging device of the prior art detects a contrast signal of the subject of FIG. 6A. However, at nighttime, the low-contrast subject is dark by itself, and its background is also dark. Therefore, a contour of the subject in FIG. 6A is blurred with the background.

As illustrated in FIGS. 6B and 6C, a shape of the contrast signal level representing a sharpness of the low-contrast subject is smooth, and it is difficult for the imaging device to find a focal point where the amplitude of the contrast signal level is maximized even by shifting the focus lens along its optical axis. For this reason, typically, overall contrast levels within a drivable range of the focus lens are measured, and the focus lens is shifted to a position where the contrast signal level is maximized within this driving range.

However, in the method described above, in order to shift the focus lens across the entire drivable range, time is necessary to complete the processing. In addition, a defocused image is continuously obtained for a long time. Furthermore, the maximum amplitude position and the focus position may not match each other due to a noise or the like. In this case, the AF function may stop in a defocus state.

Such a problem is generated due to a basic algorithm of the contrast-based method, that is, it is difficult to know where a subject is placed when the AF operation is performed.

For this reason, it is desirable to determine the driving range of the focus lens having the contrast-based AF function in advance.

JP-2004-126291-A discusses a pan-tilt-zoom (PTZ) camera in which each maximum focal length is stored in a nonvolatile memory by associating with a pan/tilt angle, and the AF operation is performed by driving the focus lens to the near side of the stored focal length in order to obtain a focus state.

### SUMMARY OF THE INVENTION

In the technique discussed in JP-2004-126291-A, if the data stored in the nonvolatile memory has an initial state when the PTZ camera performs the AF operation, the focal length in the event of the AF operation stop is stored by associating with the current pan/tilt angle of the PTZ camera. Then, when the AF is performed at the pan/tilt angle stored as the data, the AF operation is performed only in the near side of the focal length by referring to this data regarding the focal length. In addition, in the technique discussed in JP-2004-126291-A, whether or not a certain condition is satisfied is determined for the focal length stored in the memory during the AF operation. If it is determined that a subject is placed far away from the focal length, the AF operation is performed in a position far from the focal length. In addition, under such a condition, if the focal length where the AF operation stops is far from the focal length already stored by associating with the pan/tilt angle, the data is updated such that the far focal length is associated with the pan/tilt angle. Through this operation, it is possible to perform the AF operation only for the near side of the subject corresponding to the maximum distance at that angle.

However, in this technique, the focus lens is shifted in the near side relative to the maximum distance at all times. Therefore, in general, if a focal length of a zoom/focus lens is long in particular, the focus position of the focus lens is significantly different between the near and far sides. For this reason, even when the focus lens driving range is limited, for example, in the near side, a blurring state may continuously remain, and it is difficult to reduce the focusing time accordingly. In addition, in the technique described above, the farthest focal length is stored regardless of the zoom position. Therefore, it fails to consider a depth of field depending on the focal length. For example, the farthest focal length photographed at the wide end position may not necessarily match a focal length of the farthest subject. Furthermore, in the technique described above, it is necessary to associate the pan/tilt angle of the PTZ camera with the focal length. Therefore, it is difficult to apply this technique to a simple zoom/focus lens.

In this regard, it is desirable to consider a near-side focal length without limiting to a far-side focal length in order to reduce a blurring state and shorten the focusing time. In addition, it is effective to determine the driving range based on magnification information instead of the pan/tilt angle information.

In view of the aforementioned problems, an object of the present invention is to provide a focus control device capable of appropriately performing a focus control for both a typical subject and a low-contrast subject.

A focus control device includes: a driving unit configured to drive a focus lens; a storage unit configured to store subject information obtained through a focus lens and a zoom lens; and a controller configured to obtain a focus lens driving range on the basis of the subject information including previous focus states stored in the storage unit and scan a focus state by minimizing the focus lens driving range to perform an autofocus operation.

According to the present invention, it is possible to provide a focus control device capable of appropriately performing a focus control for both a typical subject and a low-contrast subject.

### BRIEF DESCRIPTION OF THE DRAWINGS

FIG. 1 is a block diagram illustrating an entire configuration of an imaging device according to an embodiment of the invention;

FIG. 2 illustrates an exemplary subject information table 200 according to an embodiment of the invention;

FIG. 3 illustrates an exemplary magnification information table 300 according to an embodiment of the invention;

FIG. 4 illustrates an exemplary distance information table 400 according to an embodiment of the invention;

FIGS. 5A to 5C illustrate an exemplary daytime crossroads environment where the present invention is effectively applied;

FIGS. 6A to 6C illustrate an exemplary nighttime crossroads environment in the same place as that of FIGS. 5A to 5C where the present invention is effectively applied; and

FIG. 7 is a flowchart illustrating a processing example of the AF operation performed by the imaging device according to an embodiment of the invention.

### DESCRIPTION OF THE PREFERRED EMBODIMENTS

A focus control device according to the present invention includes a driving unit, a contrast signal generator, a controller, and a storage unit. An imaging sensing unit photographs an optical image of a subject focused by a focus lens and outputs an image signal. A contrast signal is generated from the image signal corresponding to a detection area set within a photographic sensing area of the image sensing unit.

The controller stores subject information, including a focus state, in the storage unit when the subject is focused. In this case, the subject information contains a distance to the subject or a magnification calculated on the basis of a focus lens position in the focus control device.

Meanwhile, in order to perform the AF operation, the controller determines a range for driving a focus lens group for the AF operation by referring to information regarding the distance and the magnification from the subject information obtained in the event of the focusing of the past and stored in the storage unit. Then, the controller performs the AF operation within that range. In this case, if a predetermined slope between a contrast signal amplitude (contrast signal level) and a ratio of the focus lens shift amount (contrast change rate) is not detected during the AF operation, the focus lens driving range is not limited. As a result, it is possible to accurately perform the AF control. Since scanning of the focus position is not performed in unnecessary places during the AF operation, it is possible to more rapidly obtain the focus state.

An imaging device and a focus control device according to an embodiment of the invention will now be described with reference to the accompanying drawings. Throughout the description and the drawings, like reference numerals denote like elements, and they will not be described repeatedly.

### (1) Configuration of Imaging Device

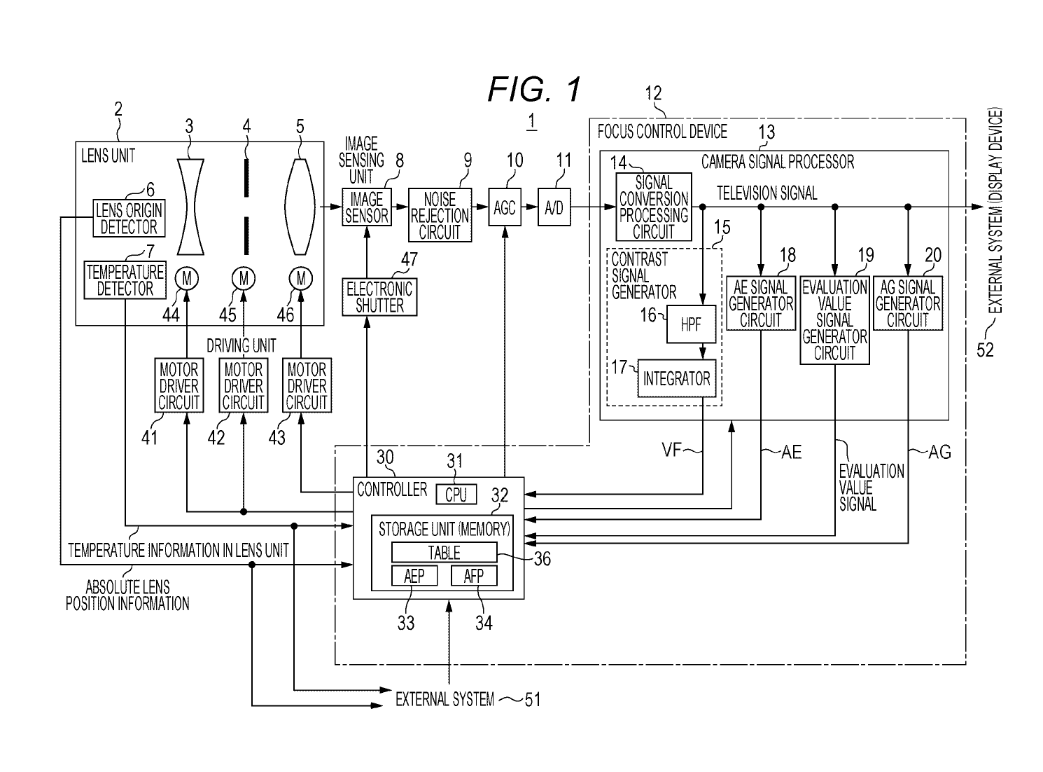

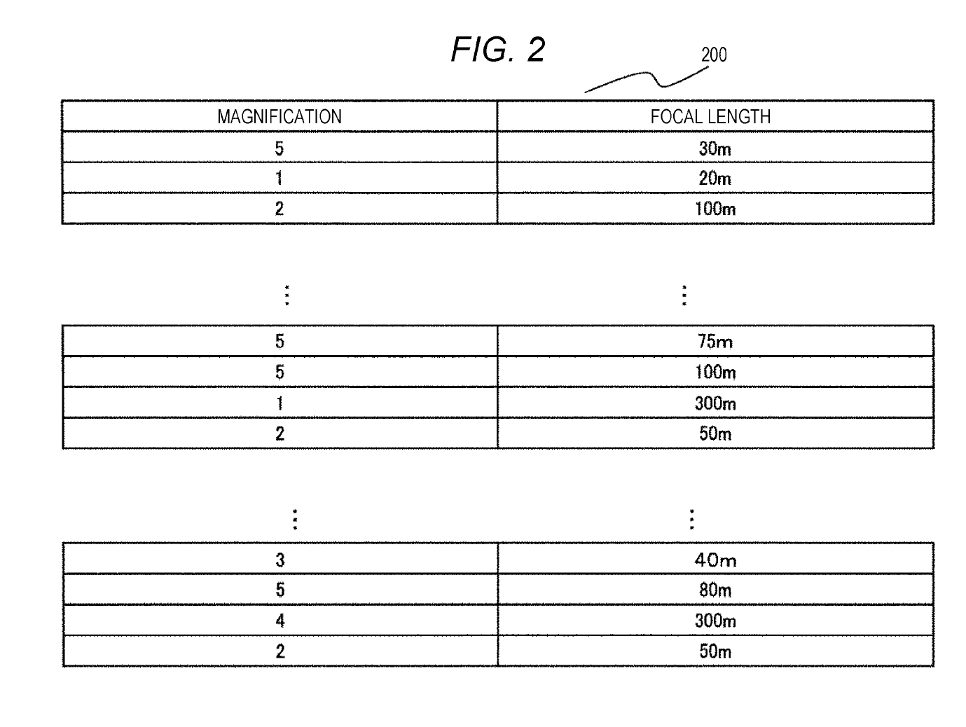

FIG. 1 is a block diagram illustrating a configuration of the entire imaging device 1 according to an embodiment of the invention.

The imaging device 1 includes a lens unit 2, an image sensor 8, a noise rejection circuit 9, an automatic gain control circuit (or auto gain controller: AGC) 10, an analog/digital converter circuit (A/D) 11, and a focus control device 12. In addition, the imaging device 1 has a motor driver circuit 41 to 43 and an electronic shutter 47. The imaging device 1 is used as, for example, a monitoring camera, but may also be embedded in a personal camera or a mobile terminal.

The lens unit 2 includes a variator lens group 3 that changes a zoom-in/out ratio by changing power of a flux of light received from a subject, a diaphragm 4 for adjusting the amount of the received light, and a focus lens group 5 (as an example of the focus lens) having a focal point control function. The lens unit 2 focuses an optical image of the subject on a light-receiving surface of the image sensor 8 such as a charge coupled device (CCD).

The lens unit 2 includes a lens origin detector 6 such as a photo-interrupter and a temperature detector 7. The lens origin detector 6 detects absolute positions (reference positions) of the variator lens group 3 and the focus lens group 5 and transmits a detection result as absolute lens position information to a controller 30 or an external system 51 capable of communicating with the imaging device 1. In the following description, for the absolute positions of the variator lens group 3 and the focus lens group 5 detected by the lens origin detector 6, a position where the focus lens group 5 is shifted will be referred to as a “focus lens position.” In addition, a position of the focus lens group 5 where an optical image of the subject is focused will be referred to as a “focus position.”

The temperature detector 7 detects a temperature of the lens unit 2 and transmits a detection result as lens unit temperature information to the controller 30 embedded in the imaging device 1 or the external system 51 capable of communicating with the imaging device 1. The external system 51 is, for example, a control computer and may receive the absolute lens position information or the lens unit temperature information through the controller 30.

The lens unit 2 has motors 44, 45, and 46 for driving the variator lens group 3, the diaphragm 4, and the focus lens group 5, respectively. The motors 44, 45, and 46 are driven in response to a driving control signal received from the motor driver circuits 41, 42, and 43, respectively.

The image sensor 8 (as an example of the image sensing unit) photographs an optical image of the subject focused in a photographic sensing area on a light-receiving surface through the focus lens group 5 and converts this optical image into an electric signal. The obtained electric signal (image signal) is output to the noise rejection circuit 9. This image signal is subjected to a predetermined noise rejection process in the noise rejection circuit 9 and is amplified to an optimum level in the automatic gain control circuit (AGC) 10. In addition, the image signal is converted into a digital signal in the analog/digital converter circuit (A/D) 11 and is then output to the camera signal processor 13 as a digital image signal.

The focus control device 12 includes a camera signal processor 13 and a controller 30.

The camera signal processor 13 includes a signal conversion processing circuit 14, a contrast signal generator 15, an auto-exposure (AE) signal generator circuit 18, an evaluation value signal generator circuit 19, and an auto-gain (AG) signal generator circuit 20.

The signal conversion processing circuit 14 converts the digital image signal received from the A/D 11 into a standard television signal complying with a television standard such as a national television standards committee (NTSC) standard or a phase alternating line (PAL) standard and outputs it to the outside. The signal conversion processing circuit 14 transmits this television signal to an external system (display device) 52 capable of communicating with the imaging device 1 through a network. In the external system (display device) 52, an image based on the television signal is displayed on a screen of the display device.

The camera signal processor 13 has a contrast signal generator 15 (as an example of the signal generator) provided with a high-pass filter (HPF) circuit 16 and an integrator 17. The HPF circuit 16 can be used to change a cut-off frequency value freely. In addition, HPF circuit 16 generates a signal having an arbitrary frequency higher than the cut-off frequency and outputs it to the integrator 17. The integrator 17 transmits a contrast signal VF obtained by integrating the signal received from the HPF circuit 16 to the controller 30. The contrast signal generator 15 having the HPF circuit 16 and the integrator 17 can obtain a value from an arbitrary television signal area.

The image photographed from the photographic sensing area of the image sensor 8 is displayed on a display screen of the external system (display device) 52. A detection area having a rectangular frame shape is provided in the vicinity of the center of the photographic sensing area. The contrast signal generator 15 detects a contrast of a subject in the detection area and generates a contrast signal.

The contrast signal generator 15 extracts a high-frequency component of a luminance signal in the detection area from the television signal (photographic image) generated by the signal conversion processing circuit 14 using the HPF circuit 16. The high-frequency component of the luminance signal in the detection area is extracted by calculating a difference between a luminance signal (luminance value) output from a pixel within the corresponding detection area and a luminance signal output from a neighboring pixel or a pixel apart by a predetermined number of pixels. This extraction process is performed for overall pixels of the detection area. In addition, the camera signal processor 13 generates a contrast signal VF by integrating the high-frequency components of the luminance signals of overall pixels of the extracted detection area using the integrator 17 and transmits the contrast signal VF to the controller 30.

The AE signal generator circuit 18 generates an automatic iris signal AE having a signal level depending on a brightness of the current photographic image, an aperture state of the diaphragm 4 of the lens unit 2, a gain of the automatic gain control on the basis of the received television signal and transmits the automatic iris signal AE to the controller 30.

The evaluation value signal generator circuit 19 extracts a contrast signal level of a subject, a color signal, a subject distance, a luminance signal, and the like from the entire received television signal or an arbitrary area thereof and transmits them as an evaluation value signal to the controller 30.

The AG signal generator circuit 20 generates an AG signal for controlling a gain of the AGC 10 on the basis of the received television signal and transmits the AG signal to the controller 30.

The controller 30 has an information processing resource such as a central processing unit (CPU) 31 for controlling each part of the imaging device 1 and a nonvolatile storage unit (memory) 32. The storage unit (memory) 32 stores programs for implementing functions relating to this embodiment, parameters used in the programs, data generated by executing the programs, and the like. For example, the storage unit (memory) 32 stores an automatic iris data processing program (AEP) 33 and an autofocus data processing program (AFP) 34. In addition, the storage unit (memory) 32 maintains a table 36 for storing data described below. The controller 30 allows the CPU 31 to read programs, parameters, data, and the like from the storage unit (memory) 32 and execute a predetermined processing.

The controller 30 receives a control command or the like from the external system 51 connected through a communication interface. The storage unit (memory) 32 also serves as a buffer memory for temporarily storing the image data of the photographic image in the unit of frame. The storage unit (memory) 32 may also be provided outside of the imaging device 1 or the focus control device 12.

The controller 30 calls the AEP 33 from the storage unit (memory) 32 to obtain a brightness of the current photographic image from the automatic iris signal AE generated by the AE signal generator circuit 18. In addition, the controller 30 calls the AFP 34 from the storage unit (memory) 32 to calculate an automatic iris evaluation value as an evaluation value regarding the aperture state of the diaphragm 4 and the gain of the automatic gain control on the basis of the automatic iris signal AE. Furthermore, the controller 30 obtains an autofocus evaluation value as a value of the contrast signal VF generated by the contrast signal generator 15.

The controller 30 adds a subject distance for the focusing of the focus lens group 5 corresponding to the focus position to the evaluation value signal received from the evaluation value signal generator circuit 19 and stores it in the table 36 as evaluation value information.

The controller 30 controls the driving unit in order to set the focus lens group 5 in a focus state on the basis of the evaluation value information read from the table 36. In the control of the driving unit, first and second driving control signals for controlling driving of the variator lens group 3 and the diaphragm 4 are generated and output to the motor driver circuits 41 and 42, respectively. The first and second driving control signals are generated on the basis of a technique well known in the art.

The motor driver circuit 41 controls driving of the motor 44 used to shift the variator lens group 3 of the lens unit 2 along an optical axis on the basis of the received first driving control signal. The motor driver circuit 42 controls driving of the motor 45 used to drive the diaphragm of the lens unit 2 on the basis of the received second driving control signal. The automatic iris control is performed in this manner. Note that accuracy of the automatic iris control can be improved using the lens unit temperature information when the first and second driving control signals are generated.

The controller 30 controls a light amount of the optical image of the subject focused on a light-receiving surface of the image sensor 8 by controlling a shutter speed of the electronic shutter 47 on the basis of the automatic iris evaluation value. In addition, the controller 30 controls a gain of the AGC 10 on the basis of the automatic iris evaluation value.

The controller 30 detects a focus direction and a focus position on the basis of the autofocus evaluation value and generates a third driving control signal. The controller 30 transmits the third driving control signal to the motor driver circuit 43. The motor driver circuit 43 controls driving of the motor 46 used to shift the focus lens group 5 of the lens unit 2 along the optical axis on the basis of the third driving control signal. In this manner, the autofocus control for driving the focus lens group 5 to set a focus state of a subject is performed using the motor driver circuit 43 and the motor 46, so that the subject can be focused during the photographing. The motors 44 to 46 may include, for example, a stepping motor.

### (2) Determination of AF Operation Range and AF Processing Using Subject Information of Subject Information Table 200

In the AF processing of the prior art, many imaging devices perform panning, tilting, and zooming operations. The present invention has been made by focusing on a fact that, in most of the imaging devices, a photographing condition or a subject distance is set in advance, and a focal point range can be roughly estimated when a plurality of subjects are photographed. In order to implement the present invention, a subject information table 200 is used as described below, in which information on the magnification and information on the focal length in the previous focus states are stored in combination with each other.

The present invention can be effectively applied to a low-contrast subject for which it is difficult to perform focusing using a typical contrast-based AF control, and it is necessary to perform the AF by driving the focus lens across the entire driving range (hereinafter, referred to as an “entire driving range”), by improving focus performance using the AF (hereinafter, referred to as “AF performance”).

### <If a Subject is Determined as a Low-Contrast Subject During the AF Operation>

The AF control according to the present invention is an AF method for performing the AF control only in an optimum AF range using information on the focusing of the subject in the previous AF operations, that is, the subject information table 200.

The controller 30 extracts subject information having the corresponding magnification from the subject information table 200 on the basis of the current camera magnification.

The controller 30 detects a change of the currently photographed subject on the basis of a remarkable contrast change and activates the AF control by using this change as a trigger.

Then, a current magnification and an angle of view of the image projected onto the image sensor 8 from the focal length are calculated on the basis of the current variator lens position information obtained from the absolute lens position information, the magnification information table 300 representing a relationship between a position of the variator lens group and the magnification, and the distance information table 400 representing a relationship between the focus position and the focal length of the focus lens. A length of a diagonal line “current_dLine” having that angle of view is compared with a length of a diagonal line “table_dLine” having an angle of view calculated from the information of the subject information table 200. In addition, subject information having a magnification satisfying a condition that its change rate is equal to or lower than an angle-of-view change rate threshold “diff_ratioTH” is extracted.

$$\begin{matrix}[ Formula 1 ] & \\ \frac{current\_dLine}{table\_dLine} ≦ diff\_ratioTH & ( Formula 1 )\end{matrix}$$

The angle-of-view change rate threshold described above is arbitrarily determined by a camera user in advance and is stored in the table 36 as a constant. This method is effective when the number of data stored in the subject information table 200 is huge.

After the subject information of the subject information table 200 is extracted, the maximum “distanceMax” and the minimum “distanceMin” of the focal length of the magnification of the corresponding subject are obtained. In this case, the maximum “distanceMax” becomes a far-side direction, and the minimum “distanceMin” becomes a near-side direction.

The controller 30 compares a position of the focus lens group 5 having a focal point matching the maximum “distanceMax” (hereinafter, referred to as a “farthest position”) or a position of the focus lens group 5 having a focal point matching the minimum “distanceMin” (hereinafter, referred to as a “nearest position”) with the current position of the focus lens group 5 to compute their differences. Then, the controller 30 drives the focus lens group 5 toward a direction having a larger difference.

If the focus lens group 5 is driven toward the farthest position at the start of the autofocus, the AF operation is performed on the basis of a typical contrast-based AF algorithm immediately after the focus lens group 5 is driven toward the farthest position. Then, if the focus lens group 5 is shifted to the farthest position, but the maximum contrast position matching the focus position is not detected, the controller 30 shifts the focus lens group 5 toward the nearest position opposite to the farthest position. Even during this shifting, the typical contrast-based AF operation is performed to scan the focus position.

Similarly, the aforementioned operation is also performed when the focus lens group 5 is driven toward the nearest position at the start of the autofocus, and the maximum contrast position is not detected.

However, if a focus position is found even when the focus lens group 5 is shifted toward any one of the farthest position and the nearest position, the focus lens group 5 stops in that position.

The aforementioned process is effective when the focus position is placed within a range between the farthest and nearest positions. However, if a subject is placed out of the range between the farthest and nearest positions, the focus position is not found even by driving the focus lens within the range between the farthest and nearest positions.

In this regard, a focus lens driving range is obtained using the following pattern by comparing the contrast signal level and the contrast change rate with a contrast signal level threshold and a contrast change rate threshold, respectively.

(1) If a distinct focal point exists within a range between the farthest and nearest positions,

contrast signal level>contrast signal level threshold, and

contrast change rate>contrast change rate threshold,

the driving range is set between the farthest and nearest positions, and the focus lens stops at a point where the focal point is obtained.

(2) If the contrast signal level is low, but a certain change of the contrast exists within a range between the farthest and nearest positions,

contrast signal level<contrast signal level threshold, and

contrast change rate>contrast change rate threshold,

the driving range is set between the farthest and nearest positions, and a maximum value within the driving range is set as the focal point.

(3) If a certain change of the contrast does not exist within the range between the farthest and nearest positions,

contrast signal level<contrast signal level threshold, and

contrast change rate<contrast change rate threshold,

the focus lens is driven between the farthest and nearest positions, and the driving range is then expanded.

In the aforementioned algorithm, a necessary driving range is estimated in advance, and the focus lens is then driven. Therefore, it is possible to reduce the focus lens driving range in various processes in which the focus lens is to be driven across the entire driving range by nature. Therefore, it is possible to reduce a blur image and a focusing time. Furthermore, this algorithm can be applied to various cameras and may be implemented just by obtaining information on the magnification and the focus position considered as being indispensable for the AF camera.

A specific example of the aforementioned algorithm will be described.

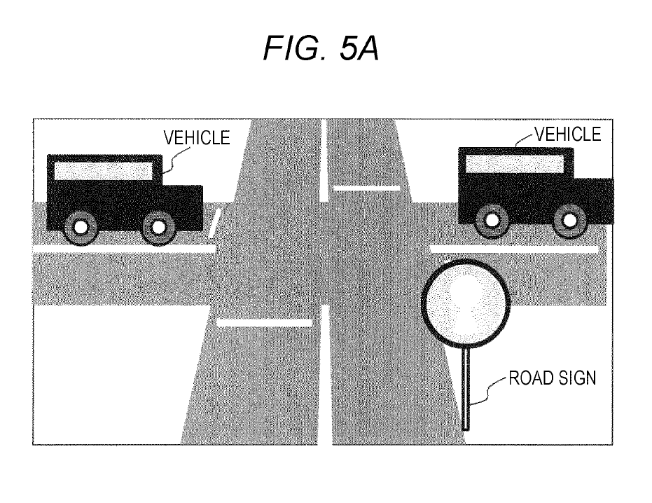

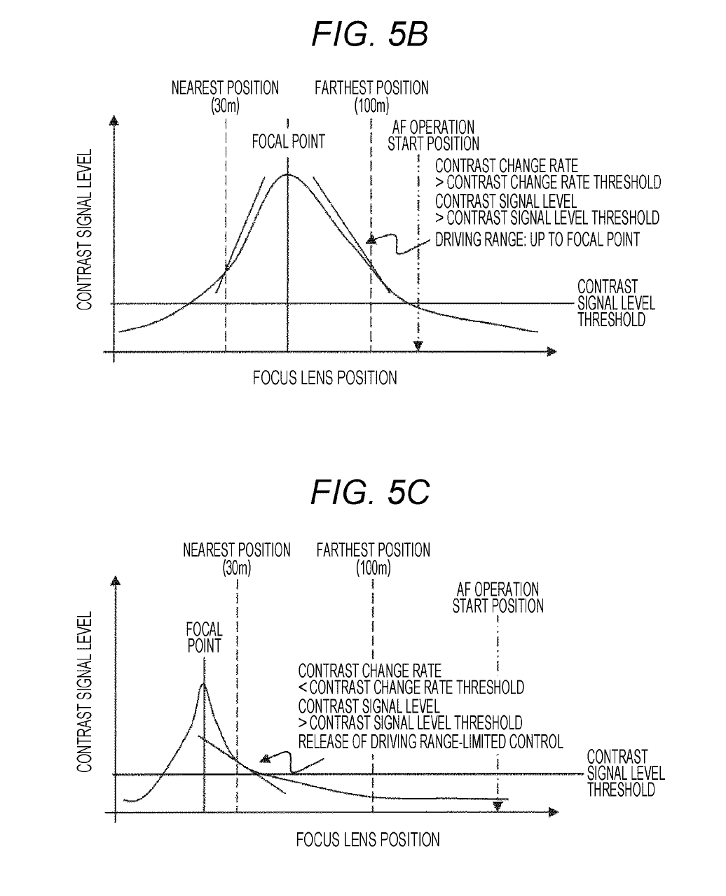

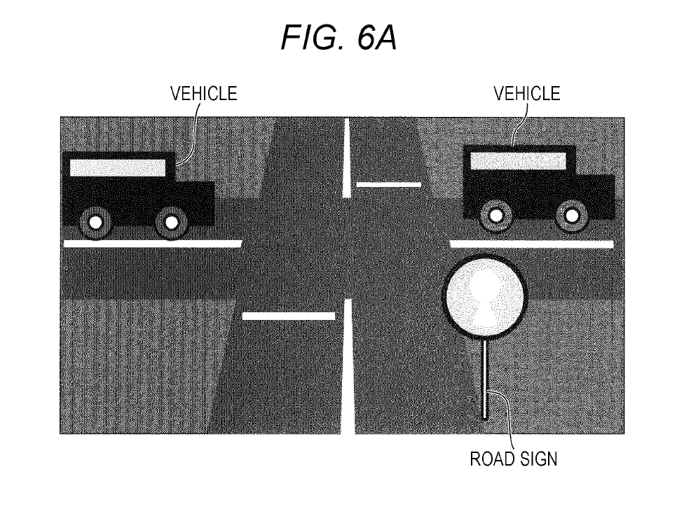

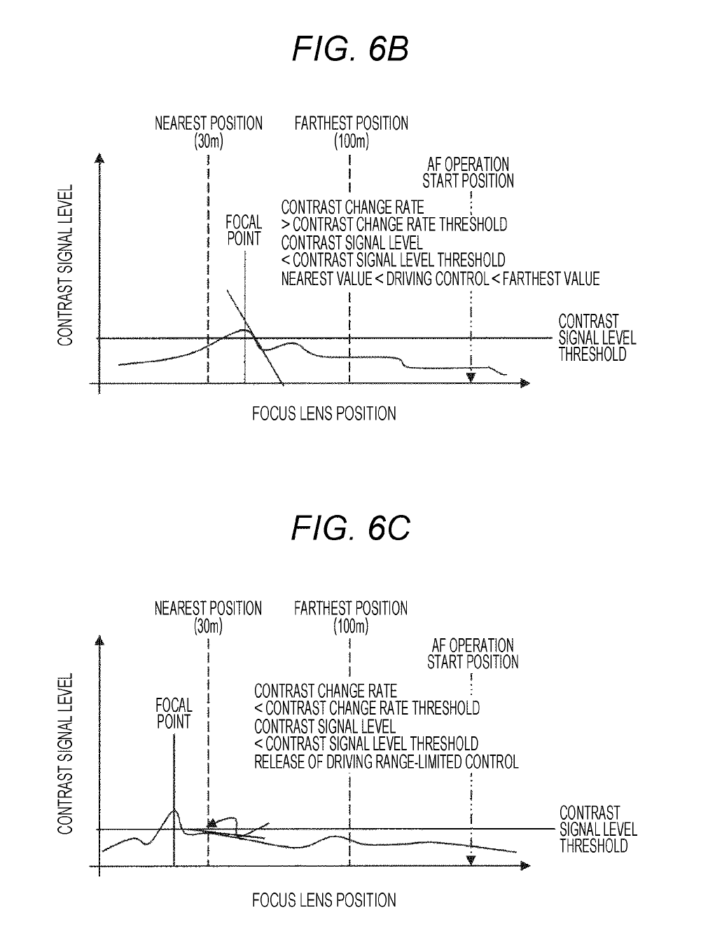

FIGS. 5A to 5C and 6A to 6C illustrate subjects and environments where the present invention can be effectively applied. FIG. 5A illustrates a crossroads at daytime, and FIG. 6A illustrates a crossroads at nighttime. FIG. 5B illustrates a relationship between the contrast signal level and the focus lens position when the road sign placed in the near side as a part of FIG. 5A is set as a center of the image. FIG. 5C illustrates a relationship between the contrast signal level and the focus lens position when the car placed in the far side in FIG. 5A is set as a center of the image. FIGS. 5B and 5C illustrates a relationship between the contrast signal and the focus lens position of FIG. 5A, and FIG. 6B illustrates a relationship between the contrast signal level and the focus lens position when the road sign placed in the near side as part of FIG. 6A is set as a center of the image. Similarly, FIG. 6C illustrates a relationship between the contrast signal level and the focus lens position when the car placed in the far side in FIG. 6A is set as a center of the image.

Here, the AF operation according to the present invention will be described, in which the subject information is obtained and stored by performing the AF operation several times under the environment of FIG. 5A. Under the environment of FIG. 5A, if the AF operation is performed from a position where the focus lens is focused in the farthest side (hereinafter, referred to as a “far end”), the focal point is significantly deviated, and the image is blurred before a start of the AF operation.

After the start of the AF operation, data corresponding to a magnification close to the current magnification are selected from the subject information table 200, and a maximum focal length “distanceMax” and a minimum focal length “distanceMin” are obtained from the selected information.

According to this embodiment, it is assumed that the magnification of the subject information obtained from Formula (1) is set to “5.” If the focal length corresponding to the magnification of “5” is obtained from the subject information table 200, the minimum focal length becomes “30 m,” and the maximum focal length becomes “100 m.”

The focus lens is driven between the current position of the focus lens group 5 and the nearest position, that is, “30 m” in this case.

As described above, in the processing according to the present invention, when the AF operation is performed, the focus lens is driven from an initial focus lens position to the farthest or nearest position. The initial focus lens position is placed between the farthest and nearest position, and the focus lens is driven up to the remaining marginal position where the focus lens has not arrived (the farthest or nearest position of the corresponding magnification). This control will be referred to as a “range-limited control.”

In FIG. 5B, a distinct focal point exists within the range between the farthest and the nearest positions. Therefore, the driving range is set to a range from the farthest position to the nearest position.

A maximum contrast signal level is detected while the focus lens position is shifted from the AF start position to the nearest position (30 m). In addition, the focusing is performed at the maximum contrast signal level.

In FIG. 5C, if a peak exists out of the range between the farthest and nearest positions, and the contrast change rate is equal to or lower than the contrast change rate threshold “contrastDiffTH” (a gradient in the driving range between the nearest and farthest values is equal to or lower than a certain value), the range-limited control is released, so that it is possible to obtain a focus state without an unfocused stop in a blurring state that may be generated when the focus lens group 5 stops in a marginal position.

In the case of FIGS. 5A to 5C, the focal point is determined distinctly. Therefore, the subject information is stored in the subject information table 200.

Next, a case where the processing according to the present invention is applied under the environment of FIG. 6A will be described. FIG. 6A is the nighttime version of the environment of FIG. 5A. A relationship between the contrast and the focus lens position under the environment of FIG. 6A is illustrated in FIGS. 6B and 6C. In this case, even when the contrast-based AF operation is performed, it is difficult to find a peak position due to a low contrast. Under the environment of FIG. 6A, typically, the focus lens is shifted across the entire driving range and is then shifted to a point of the highest contrast signal level.

If the processing according to the present invention is executed, under the condition of FIG. 6B, the controller 30 first drives the focus lens group 5 from the AF start position to the nearest position, that is, toward a focus position of “30 m.” In FIG. 6B, since a value of the contrast signal level is small, a low-contrast state is continuously determined. However, since the contrast change rate is partially higher than the contrast change rate threshold, the focus lens group 5 is continuously driven up to the nearest position without releasing the range-limited control. In addition, during the shifting of the focus lens group 5, a position of the maximum contrast signal level is continuously recorded in the table 36. After arriving at the nearest position, a position of the maximum contrast signal is read from the table 36, and this position is determined as a focal point. Then, the controller 30 shifts the focus lens group 5 to that position. If the AF operation start position is within a range between the nearest and farthest positions, the focus lens group 5 arrives at the nearest position, and the controller 30 then drives the focus lens toward the farthest position, that is, a focus position of “100 m” by changing the driving direction. The low-contrast determination is continuously performed even during this driving operation. In FIG. 6B, since the low-contrast state is continuously determined even in this case, the focus lens arrives at the farthest position without releasing the range-limited control. Similarly, during the shifting to the farthest position, a position of the highest contrast signal level is continuously stored in the table 36.

Here, after the focus lens group 5 arrives at the farthest position, the position of the maximum contrast signal is read from the table 36, and this position is determined as the focal point. Then, the controller 30 shifts the focus lens group 5 to that position.

Through the aforementioned processing, the focus lens is prevented from being shifted out of the range between the nearest value and the farthest value in FIG. 6B, and the time taken to obtain a focus state is reduced. Therefore, it is possible to improve focus efficiency for a low-contrast subject.

Next, FIG. 6C illustrates a case where an image obtained from a low-contrast subject similar to that of FIG. 6B has a continuously smaller amplitude of the contrast, and there is no focal point within the limited range.

In this case, the contrast signal level within the range between the nearest value and the farthest value is smaller than the contrast signal level threshold, and the contrast change rate is smaller than the contrast change rate threshold. Therefore, the range-limited control is released. As a result, a focal point is scanned across the entire driving range.

By adjusting the contrast signal level threshold “contrastTH” and a contrast change rate threshold “contrastDiffTH” in consideration of the previous data stored in the subject information table and a relationship between the contrast signal level and the focus lens position, setting or releasing of the range-limited control can be determined out of the aforementioned pattern.

A user may set the contrast signal level threshold “contrastTH” and the contrast change rate threshold “contrastDiffTH” in the table 36 of the storage unit using the external system 51 in advance depending on the environment change such as when a camera is activated.

### <Method of Recording Subject Information>

Next, how the controller 30 records the subject information in the subject information table 200 will be described.

The controller 30 obtains a reliability representing a degree of whether or not the focus lens group 5 is focused during the AF operation as a numerical value representing a focus possibility at the time of completion of the AF operation by using a fact that the focus lens group 5 has a focus state as a trigger. This reliability is calculated by the controller 30 on the basis of the contrast signal level and a history of the instruction transmitted from the controller 30 to the focus lens group 5 during the start to the stop of the AF operation.

Then, the controller 30 compares the calculated reliability with a reliability threshold “r_th” which is a reference value for determining whether or not the focus lens group 5 is focused. For example, the reliability may be expressed as a binary value. If the contrast signal level is equal to or higher than a predetermined value, and the AF operation is completed while a particular subject such as a point light source is not included, the reliability is output as “1.” In addition, the reliability is compared with the reliability threshold “r_th” set to “0” as described below. As a result, it is possible to perform a process of storing only a particular condition in the subject information table 200.

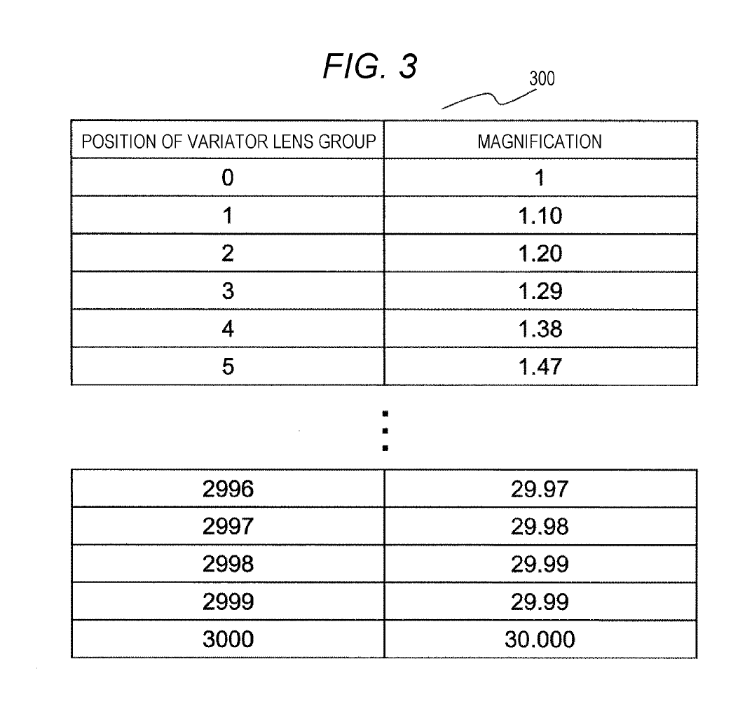

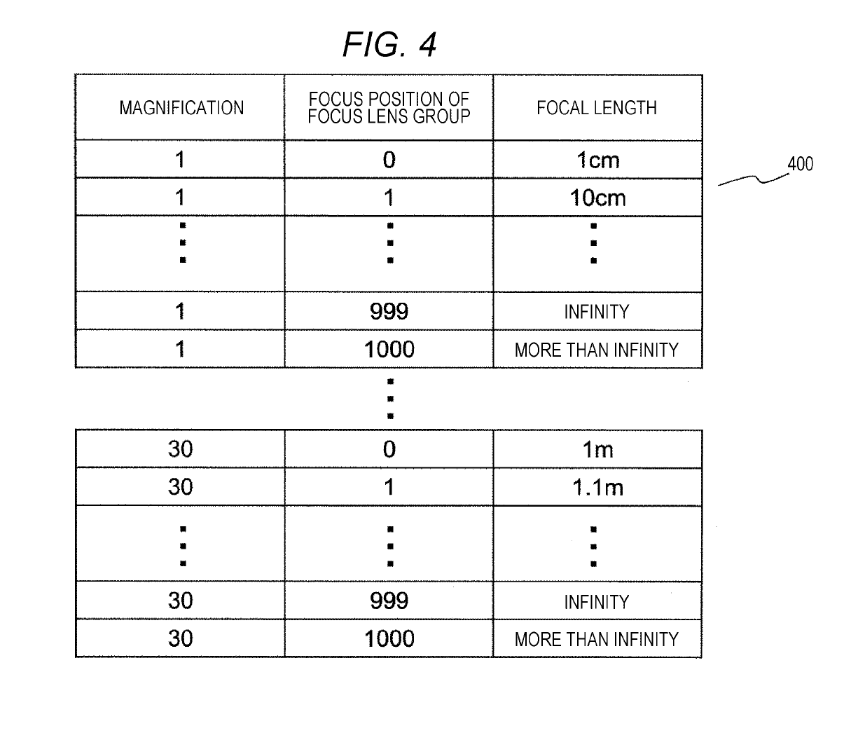

If the calculated reliability is equal to or higher than the reliability threshold “r_th,” the controller 30 obtains the focal length and the magnification from the magnification information table 300 of FIG. 3 on the basis of the current position of the variator lens group 3. After obtaining the magnification, the current focal length is calculated on the basis of the position of the focus lens group 5 from the distance information table 400 of FIG. 4, and subject information is stored in the subject information table 200 by associating the magnification and the focal length. The number of the stored subject information or a method of storing them can be determined by a user in advance. For example, STORE/DELETE of the subject information may be selected by sectioning the information on a magnification basis and fixing the number of the stored subject information. In addition, a rule on whether the subject information is stored or discarded when an overflow occurs in the number of the stored subject information may be set to a simple scheme such as a first-in-first-out (FIFO) scheme. Alternatively, whether the subject information is continuously stored in the subject information table 200 or is discarded may be determined on the basis of a predetermined algorithm.

### <Flowchart of AF Operation>

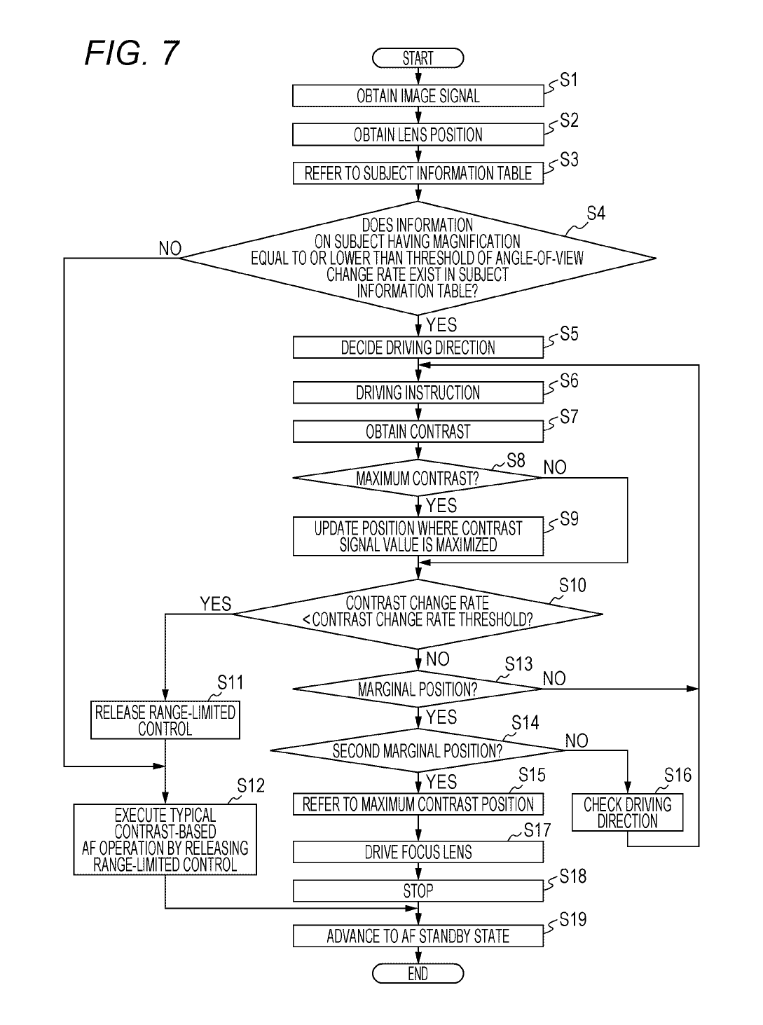

FIG. 7 is a flowchart illustrating an exemplary AF operation performed by the imaging device 1. A processing sequence obtained by executing the program stored in the storage unit (memory 32) using the controller 30 of the imaging device 1 will be described.

The controller 30 starts the autofocus control process when the power is turned on or when the subject is changed. Then, the controller 30 advances to the AF operation state.

The controller 30 performs exposure of the image sensor 8 by driving the electronic shutter 47 to allow the image sensor 8 to obtain an image signal (step S1). Then, a position of the variator lens group 3 and a position of the focus lens group 5 are obtained. After obtaining the positions of each focus lens, the focal length is obtained on the basis of that positions, and the magnification is calculated on the basis of the focal length (step S2).

Then, the controller 30 selects optimum subject information using the aforementioned calculation method (Formula 1) on the basis of the subject information table 200 (step S3). The controller 30 calculates the farthest position and the nearest position on the basis of the maximum value “distanceMax” and the minimum value “distanceMin” of the focal length associated with the subject information selected as described above and stores the farthest and nearest positions in the table 36 of the storage unit (memory) 32. If it is difficult to obtain the subject information, the range-limited control is released, and the process advances to the typical contrast-based AF control (step S4).

The controller 30 compares an absolute value of the difference between the farthest position stored in the table 36 and the position of the focus lens group 5 obtained through step S2 and an absolute value of the difference between the nearest position stored in the table 36 and the position of the focus lens group 5 obtained through the step S2. Then, the controller 30 determines a driving direction such that the focus lens group 5 is shifted to the larger difference side (step S5). In addition, the controller 30 drives the focus lens group 5 toward the instructed driving direction (step S6).

Then, the controller 30 obtains the contrast signal level on the basis of the contrast signal provided from the camera signal processor 13 and stores it in the table 36. In this case, how many times the contrast signal level is stored is determined in advance, and the contrast signal level is stored in the table 36 as many as this number (step S7).

Steps S8 and S9 are operations to store the maximum contrast signal level during this sequence of the AF operation. In step S8, the contrast signal level obtained in step S7 is compared with the maximum contrast signal level stored in the table 36 in step S7.

If the contrast signal level obtained in step S8 is higher than the contrast signal level recorded in the table 36 as a result of the comparison, a position of the focus lens group 5 corresponding to the maximum contrast signal level recorded in the table 36 is updated (step S9).

Then, in step S10, it is determined whether or not the contrast change rate “contrastDiff” is equal to or lower than the contrast change rate threshold “contrastDiffTH” during the AF operation. If this condition is satisfied, the process advances to step S11, where a typical contrast-based AF operation is performed (step S12), and the process advances to the AF standby state (step S19). If this condition is not satisfied, the range-limited control is performed.

The range-limited control is performed in steps S13 to S15.

In step S13, it is determined whether or not the current position of the focus lens group 5 is a marginal position, that is, the farthest position or the nearest position (step S13). If the focus lens group 5 is placed in the marginal position or already passes over the marginal position, it is determined whether or not this position is the second marginal position (step S14). If this position is the first marginal position, the driving direction is checked. If a position of the focus lens group 5 at the start of the AF operation is within a range between the nearest value and the farthest value, the driving direction is reversed. If the position of the focus lens group 5 is out of this range, the driving direction is maintained as it is (step S16). Then, the process returns to step S6 to drive the focus lens group 5.

Returning to step S13, if the position of the focus lens group 5 is not the marginal position, the driving direction is maintained as it is, and the process returns to step S6 to continuously drive the focus lens.

Returning to step S14, if this position is the second marginal position, by referring to the position where the contrast signal level stored in steps S7 to S9 is maximized during the driving of the focus lens group 5 (step S15), a driving instruction for shifting the focus lens group 5 to the position of the maximum contrast signal level is issued (step S17). After the focus lens arrives at the position of the maximum contrast signal level, the focus lens group 5 stops (step S18).

Then, the process advances to the AF standby state (step S19).

### (3) Other Embodiments

In the aforementioned embodiments, a case where the present invention is applied to the imaging device 1 having the configuration of FIG. 1 has been described. However, the present invention is not limited to such a case and may be widely applied to various imaging devices having other configurations.

For example, in the aforementioned embodiments, the range of the range-limited control is determined from the maximum focal length and the minimum focal length associated with the subject information of the subject information table 200 and obtained from the information of the previous focus state and the magnification of the subject information. However, the present invention is not limited thereto. Instead, the range of the focus lens position may be obtained from the most frequently used value in a distribution of the data selected from the subject information table. That is, the range-limited control may be performed such that the focus lens is shifted to a near side or a far side located in a predetermined distance from the most frequently used value of the selected data.

For example, whether or not the range-limited control is executed may be determined on the basis of any one of the contrast signal level and the contrast signal level change rate instead of the combination thereof.

Note that the present invention is not limited to the aforementioned embodiments, and various other applications or modifications may be possible without departing from the scope and spirit of the invention as attached in the claims.

For example, although configurations of the devices and the systems are specifically and particularly described in the aforementioned embodiments, it is not necessary to provide all of the elements described above. In addition, a part of the elements of a certain embodiment may be substituted with an element of another embodiment, and an element of a certain embodiment may also be added to a configuration of another embodiment. Furthermore, addition, deletion, or substation of any element may also be possible for a part of the configuration of each embodiment.

In the drawings, all of the control signal lines or the information signal lines are not necessarily illustrated depending on elements. Instead, only those necessary for the description purposes are illustrated. It would be understood that most of the elements are connected to each other in practice.

1. A focus control device comprising:
a driving unit configured to drive a focus lens;
a storage unit configured to store subject information obtained through a focus lens and a zoom lens; and
a controller configured to obtain a focus lens driving range on the basis of the subject information including previous focus states stored in the storage unit and scan a focus state by minimizing the focus lens driving range to perform an autofocus operation.

2. The focus control device according to claim 1, wherein the controller obtains a position and a magnification of the lens and performs computation using a magnification and a focal length of the subject information including previous focus states stored in the storage unit to obtain the focus lens driving range from a value of the subject information corresponding to an approximate magnification.

3. The focus control device according to claim 1, wherein the controller determines whether or not an autofocus operation is performed by expanding the driving range if it is difficult to obtain a focus state within the focus lens driving range.

4. The focus control device according to claim 2, wherein the controller obtains a contrast signal amplitude (contrast signal level) and a ratio between the contrast signal level and a focus lens shift amount (contrast change rate) from a contrast signal obtained by driving the focus lens, and compares the contrast signal level and the contrast change rate with a contrast signal level threshold and a contrast change rate threshold, respectively, to determine the focus lens driving range.

5. The focus control device according to claim 3, wherein the controller performs an autofocus operation within a driving range if a contrast level change rate of the driving range is equal to or higher than a threshold, the driving range being established by setting focus lens positions corresponding to a farthest focal length and a nearest focal length of the subject information including previous focus states as upper and lower limitations, respectively.

6. The focus control device according to claim 2, wherein the controller scans a focus state within a driving range, the driving range being established by setting focus lens positions corresponding to a farthest focal length and a nearest focal length of the subject information obtained through the computation as upper and lower limitations, respectively.

7. The focus control device according to claim 4, wherein the controller performs an autofocus operation by expanding the driving range if the contrast level change rate is equal to or lower than a threshold within the driving range, the driving range being established by setting focus lens positions corresponding to a farthest focal length and a nearest focal length of the subject information including previous focus states as upper and lower limitations, respectively.

8. An imaging device provided with the focus control device according to claim 1.

9. A focus control method comprising:
driving a focus lens;
storing subject information obtained through the focus lens and a zoom lens;
obtaining a focus lens driving range from the subject information including previous focus states to perform an autofocus operation; and
scanning a focus state by minimizing the focus lens driving range.
